(19) United States
(12) Patent Application Publication
(10) Pub. No.: US 2015/0099052 A1
(43) Pub. Date: Apr. 9, 2015

(54) NUTRITIONALLY BALANCED FOOD OR BEVERAGE PRODUCT

(71) Applicant: SAPPORO HOLDINGS LIMITED, Hamilton (NZ)

(72) Inventors: Guy William Clayton Pope-Mayell, Hamilton (NZ); Ross Dixon Rotherham, Hamilton (NZ); Jason Paul Rogers, Hamilton (NZ)

(21) Appl. No.: 14/384,873

(22) PCT Filed: Mar. 13, 2013
(86) PCT No.: PCT/NZ2013/000040

§ 371 Date: Sep. 12, 2014

(30) Foreign Application Priority Data
Mar. 13, 2012 (NZ) 598764

(51) Int. Cl. A23L 1/29; A23L 2/52

(52) U.S. Cl. CPC A23L 1/296; A23L 2/52; A23V 2002/00
USPC 426/590; 426/656

(57) ABSTRACT

A pre-packaged food or beverage product is provided which includes macronutrients in the form of protein, carbohydrate and fat, wherein each complete serving of the product has the same relative proportions of the NRV for each macronutrient, and wherein the fibre content in the serving provides a proportion of the NRV that is at least 5% greater than the proportions of the NRV provided by the fat, protein or carbohydrate in a serving.

### STATEMENT OF CORRESPONDING APPLICATIONS

This application is based on the Provisional specification filed in relation to New Zealand Patent Application Number 598764, the entire contents of which are incorporated herein by reference.

### TECHNICAL FIELD

The Invention relates to a nutritionally balanced food or beverage product for human consumption and process for making same.

### BACKGROUND ART

Today there are a multitude of manufactured food and beverage products in the market place which have been developed by food technologists and dieticians. The primary driver for most manufactured and commonly available food products available today, are taste, followed closely by shelf life and texture. These drivers in turn dictate the overall nutritional composition, and choice of ingredients of the majority of so called healthy food products and beverages, available on supermarket shelves.

In addition, there are also many food and beverage products which have been designed to help or prevent a number of medical conditions or perform a particular function that helps in an individual achieving a particular goal. For example, there are healthy snacks such as nutrition bars with added calcium to address osteoporosis. Another example is protein bars which are high in protein and low in carbohydrate. So in general most tailored food products tend to solely focus on one, or may be at best two, nutritional goals.

However, with increasingly busy lifestyles and most people being starved for time, there is now, a greater need than ever, for food and beverage products, which if consumed: provide a person with appropriate amounts of all essential macronutrients, so as to maintain a healthy diet and a healthy body. Particularly, if said food or beverage products are to be consumed over a prolonged period of time. The documentary Supersize Me is a poignant example of how manufactured food which is not balanced, can if consumed over an extended period of time, have extremely damaging effects on our health.

In this regard the applicant has previously developed a nutritionally balanced food product detailed in WO 2006/098644 which has the same relative proportions of calories, protein, carbohydrates, fat and saturated fat in every mouthful consumed. The food and beverage product taught in WO 2006/098644 represents what can be considered a new class of food and beverage products, one which is designed to provide a healthy person's body with that, which it actually requires. That is WO 2006/098644 teaches a food product which has macronutrients of protein, fat and carbohydrate all matched to the same percentage of the RDI—that is a food product having totally nutritionally balanced macronutrients.

In particular there exists a need for a food or beverage product which can provide a healthy snack on the one hand or can provide a person with nearly all the nutrition they may need for a day in a single, double, or multiple complete serve. It being recognised that in some situations it is not desirable or indeed possible to have a conventional three, four or more meal a day serve covering of daily intake of nutrients. Instead a person may only have one or two chances to eat a major portion of their daily nutritional needs due to the demands of their day.

In addition more and more people want to enjoy tasty pre-dinner morsels such as appetizers just prior to their main meal but not necessarily have that indulgence impact on their nutritional aims.

It would therefore be useful, if there could be provided a food and beverage product which is tailored to suit an end user's requirements yet maintains a nutritional balance with the same relative proportion of protein, carbohydrates, and fat with respect to the daily intake.

In addition there is also a need for food products which have an increased fibre content. Fibre is considered by various health organisations to be a nutrient which needs to have a higher content in many western diets. Fibre has been shown to help excrete excess cholesterol, aid digestion and the slow sugar release. Furthermore, increased fibre such as resistant starch may help prevent co-rectal cancer as well as provide an anti-inflammatory effect. It would be useful if an increased fibre food product existed which also has the other main macronutrients provided in the same relative proportions of the daily intake.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

It is an object of the present invention to address the foregoing problems or at least to provide the public with a useful choice.

Further aspects and advantages of the present invention will become apparent from the ensuing description which is given by way of example only.

### DEFINITIONS

The term ‘carbohydrate’ as used herein includes both simple (mono and disaccharides) and complex (polysaccharides) carbohydrates. One example of a simple carbohydrate are sugars.

The term ‘fat’ as used herein includes ‘saturated’ fat and other subgroups of fats.

The term ‘NRV’ or ‘Nutritional Reference Value’ as used herein refers to reference amounts used to provide dietary nutritional guidance on the daily intake of nutrients including carbohydrates, protein, and fat. The reference amounts are typically published in food regulations or in accepted industry codes of practice or guidelines for the purpose calculating and expressing nutrient amounts in terms of: a person's Daily Intake or equivalent terms including: Daily Nutritional Requirement, Daily Allowance, Daily Value, Recommended Daily Value, Recommended Daily Intake, Guideline Daily Amounts or other similar terms or abbreviations thereof.

Representative examples of such published nutrient regulations and guidelines include:
Daily Reference Values given in USFDA Code of Federal Regulations 21 CFR 101.9, 1996;
% Daily Intake reference values given in the Australia New Zealand Food Standards
GDA—Guideline Daily Amounts as published by the Food and Drink Federation, UK
Reference Standards given in The Canadian Food and Drug Regulations and amendments;
   such as may be periodically updated from time to time. A summary of the above published nutrient regulations and guidelines for Australia/New Zealand, UK, US and Canada is shown in Table 1 and is for illustrative purposes only.

TABLE 1

| | AUS/NZ | | | |
|---|---|---|---|---|
| | DV/DAILY | UK | US | Canada |
| | INTAKE | GDA (UK) | RDV | RDV |
| Energy | 8700 | 8360 | 8360 | 8360 |
| (kJ) | | | | |
| Cal | 2081 | 2000 | 2000 | 2000 |
| Protein | 50 g | 50 g | 50 g | None set |
| Fat, Total | 70 g | 70 g | 65 g | 65 g |
| Fat Sat | 24 g | 20 g | 20 g | 20 g |
| Cholesterol | None set | None set | 300 mg | 300 mg |
| Total Carb | 310 g | 270 g | 300 g | 300 g |
| Sugars | 90 g | 90 g | None set | None set |
| Fibre | 30 g | 25 g | 25 g | 25 g |
| Sodium | 2300 mg | 2400 mg | 2400 mg | 2400 mg |

### SUMMARY OF INVENTION

According to first aspect of the present invention there is provided a process for manufacturing a food or beverage product which is based upon the nutritional reference values (NRV) as a starting point and which has the macronutrients of protein, carbohydrate and fat all balanced with respect to their relative percentage of the NRV and has fibre present in an amount which exceeds the relative percentage of the NRV to which the aforementioned macronutrients are matched, the process comprising the steps of:
(i) selecting a percentage of the NRV that will be used to determine the amount of protein, carbohydrate and fat in the product, from any one of the following documents:
   Daily Reference Values given in USFDA Code of Federal Regulations 21 CFR 101.9, 1996;
   % Daily Intake reference values given in the Australia New Zealand Food Standards;
   GDA—Guideline Daily Amounts as published by the Food and Drink Federation, UK;
   Reference Standards given in The Canadian Food and Drug Regulations and amendments;
   all as published on 13 Mar. 2012; and
(ii) combining the protein, carbohydrate, fat macronutrients in amounts that accord to the selected percentage of the NRV so that each complete serving of the product has substantially the same percentage of the NRV;
(iii) adding fiber to the product so that a complete serving of the product provides fiber in a proportion of the NRV that is at least 5% greater than the percentage of the NRV provided by the fat, protein or carbohydrate in a serving.

It will be understood that some or all of the individual macronutrients will generally present in various quantities within individual ingredients selected for creating a recipe such as would be understood by a person skilled in the art. For this reason step (iii) in practice may a number of sub-steps: which may include but not be limited to, blending, cutting, mixing one or more of the ingredients separately or together; prior to incorporating with one or more other ingredients, before finally combining/bringing together the macronutrients so as to create a complete serving.

According to a second aspect of the present invention there is provided a pre-packaged food or beverage product substantially as described above wherein the proportion of the NRV selected for the macronutrients is selected from substantially 5%, 50% to 95% of the NRV.

According to a third aspect of the present invention there is provided a pre-packaged food or beverage which includes one or more minerals and vitamins in the same relative proportions of the NRV as the selected macronutrients.

According to a fourth aspect of the present invention there is provided a pre-packaged food or beverage product which includes fibre in the same relative proportions of the NRV as the selected macronutrients.

According to fifth aspect of the present invention there is provided a pre-packaged food or beverage product which includes macronutrients in the form of protein, carbohydrate and fat wherein each complete serving of the product has the same relative proportions of the NRV for each macronutrient and wherein the proportion of the NRV selected for the macronutrients is selected from substantially 5%, 50% to 95% of the NRV.

According to sixth aspect of the present invention there is provided a pre-packaged food or beverage product which includes macronutrients in the form of protein, carbohydrate and fat wherein each complete serving of the product has the same relative proportions of the NRV for each macronutrient and wherein the fibre content in the serving provides a proportion of the NRV that is at least 5% greater than the proportions of the NRV provided by the fat, protein or carbohydrate in a serving.

### BEST MODES AND ILLUSTRATIVE EXAMPLES

The following examples are illustrative only and are not intended to limit the scope of the invention and are based on % Daily intake reference values given in the Australia New Zealand Food Standards.

### Example 1

A frozen meal which provides about 50% of the NRV for the macronutrients protein, carbohydrate and fat and 55% of the NRV for fibre.

| | | |
|---|---|---|
| Protein | 25 | g |
| Carbohydrate | 155 | g |
| Fat | 35 | g |
| Fibre | 16.5 | |

In this example this frozen meal is a honey chicken stir-fry

This meal is great for people who may have missed lunch or breakfast.

### Formulation to Achieve Example 1

Honey Chicken Stir-Fry frozen ready meal, with 911 g serve size

| | | % of sauce (in-going |
|---|---|---|
| Honey Sauce | Ingredient | ingredient weight) |
| Step 1 | Avon maize starch | 3.90% |
| | Acacia gum | 1.80% |
| | sugar | 3.80% |
| Step 2 | Water | 49.40% |
| | Honey | 13.90% |
| | soy sauce | 12.70% |
| Step 3 | Onion | 12.70% |
| | garlic | 1.30% |
| | ginger | 0.10% |
| | salt | 0.03% |
| | turmeric | 0.10% |
| | Cayenne pepper | 0.30% |
| | Totals | 100% |

| Stir-fry | Ingredient | % of Stir-fry |
|---|---|---|
| Step 4 | Diced chicken | 5.7% |
| | Rice Bran Oil | 4.6% |
| Step 5 | Carrots | 13.1% |
| | Capsicum red | 12.2% |
| | Beans green | 12.2% |
| | Broccoli | 4.9% |
| Step 6 | Honey Sauce | 47.4% |

| Finished | | |
|---|---|---|
| Meal | Ingredient | % of meal |
| Step 7 | Rice white polished | 28.63% |
| | boiled | |
| | Stir-fry | 71.37% |
| | Totals | 100% |

### Method:

The sauce may be prepared by dispersing the pre-blended acacia gum, sugar and maize starch in the water, honey and soy sauce (@40-45° C.) in a cooking vessel. This should be heated to 80° C., prior to adding all other sauce ingredients. The sauce should then be brought to the boil and simmered for 10 minutes. A solids content of about 32% is desired. The stir-fry may be prepared by frying the diced chicken in the rice bran oil until browned, adding the vegetables followed by the prepared sauce. The stir-fry may be cooled and then portioned with boiled white rice (portion size of 911 g comprising approximately 28%/Rice 72%), packed in microwaveable trays and snap frozen.

### Example 2

A beverage which provides 5% of the NRV for the macronutrients protein, carbohydrate and fat and 5.5% of the NRV for fibre.

| | |
|---|---|
| Protein | 2.5 g |
| Carbohydrate | 15.5 g |
| Fat | 3.5 g |
| Fibre | 1.65 g |

This beverage is designed to provide people with a kick start to their day particularly if they are going to have a delayed breakfast, or want a low calorie alternative to breakfast where they might have several drinks over the course of the morning perhaps instead of coffee.

### Formulation to Achieve Example 2

Ready to drink beverage—200 ml Serve

| | | % in-going ingredient |
|---|---|---|
| | Ingredient | weight |
| Part A | Soy protein isolate | 0.40% |
| | Whole milk powder | 3.30% |
| | Water | 18.90% |
| Part B | Brown Rice Syrup | 4.70% |
| | Honey | 2.50% |
| | Water | 66.60% |
| | Oligofructose | 0.90% |
| | Maltodextrin | 0.40% |
| | Carrageenan | 0.04% |
| | Microcrystalline | 0.32% |
| | cellulose | |
| Part C | Rice Bran Oil | 0.60% |
| | Coconut Oil | 0.20% |
| Part D | Vanilla flavour | 1.09% |
| | Totals | 100.00% |

### Method:

The soy protein isolate and whole milk powder should be dispersed using shear/agitation in Part A water (@40-50° C.) and left to hydrate (assisted by agitation) for 10-15 minutes. In a separate vessel, the carrageenan, microcrystalline cellulose, maltodextrin and oligofructose should be dispersed in Part B water (@40-50° C.). Dispersion may be aided by pre-blending of the dry powders. These should be left to hydrate (with agitation) for 15-20 minutes, prior to adding and blending the brown rice syrup, honey and soy protein isolate/whole milk powder solution (part A). The rice bran oil and pre-melted coconut oil should then be added and blended using shear and finally the flavor added and mixed. This mixture is then processed by ultra heat treatment (approximately 140° C. for 6-7 seconds) and homogenized, prior to aseptic packaging in 200 ml package.

### Example 3

A liquid food for naso-gastric delivery which contains 95% of the NRV for the macronutrients protein, carbohydrate and fat and 100% for fibre.

| | |
|---|---|
| Protein | 47.5 g |
| Carbohydrate | 294.5 g |
| Fat | 66.5 g |
| Fibre | 30 g |

### Formulation to Achieve Example 3

2700 ml of Liquid food for nasogastric delivery, packaged in a sterile bladder.

| | | % in-going ingredient |
|---|---|---|
| | Ingredient | weight |
| Part A | Soy protein isolate | 0.40% |
| | Whey Protein | 0.30% |
| | Concentrate | |
| | Whole milk powder | 4.50% |
| | Water | 23.70% |
| Part B | Inulin | 1.30% |
| | Maltodextrin | 0.70% |
| | Carageenan | 0.05% |
| | Microcrystalline | 0.40% |
| | cellulose | |
| | Rice Syrup Solids | 4.40% |
| | Water | 55.80% |
| Part C | Brown Rice Syrup | 6.00% |
| Part D | Rice Bran Oil | 0.80% |
| | Sunflower oil | 0.40% |
| Part E | Vanilla flavour | 1.39% |
| | Totals | 100% |

### Method:

The soy protein isolate, whey protein concentrate and whole milk powder should be dispersed using shear/agitation in Part A water (@40-50° C.) and left to hydrate (assisted by agitation) for 10-15 minutes. In a separate vessel, the carrageenan, microcrystalline cellulose, maltodextrin, rice syrup solids and inulin should be dispersed in Part B water (@40-50° C.). Dispersion may be aided by pre-blending of the dry powders. These should be left to hydrate (with agitation) for 15-20 minutes, prior to adding and blending the brown rice syrup (part C) and soy protein isolate/whey protein concentrate/whole milk powder solution (Part A). The rice bran oil and sunflower oil (Part D) should then be added and blended using high shear. Finally the flavor is added and mixed. This mixture is then processed by ultra heat treatment (approximately 140° C. for 6-7 seconds) and homogenized, prior to aseptic packaging into a sterile bladder.

### Example 4

A snack which has 5% of the NRV for the macronutrients protein, carbohydrate and fat and 5.5% of the NRV for fibre.

| | |
|---|---|
| Protein | 2.5 g |
| Carbohydrate | 15.5 g |
| Fat | 3.5 g |
| Fibre | 1.65 g |

This is frozen pack of samosa's wherein each samosa can be considered a complete serve and has 5% of your NRV. This frozen pack can be used as a starter for a frozen meal which is designed to provide 25% of the NRV based on the assumption a person consumes 5 samosa's.

### Formulation to Achieve Example 4

Frozen Samosa snack, 54 g serve

| | | | % of finished product |
|---|---|---|---|
| | | | (in-going ingredient |
| | Ingredient | | weight) |
| | | % of pastry | |
| | | (in-going | |
| | | ingredient weight) | |
| Pastry | Flour | 57.30% | 17.70% |
| | Soy protein isolate | 0.50% | 0.10% |
| | Rice bran oil | 6.20% | 1.90% |
| | Egg yolk | 6.90% | 2.10% |
| | Water | 27.50% | 8.50% |
| | Glycerine | 0.20% | 0.10% |
| | Salt | 1.40% | 0.40% |
| | | 100.00% | |
| | | % of filling | |
| | | (in-going | |
| | | ingredient weight) | |
| Filling | Onion | 10.20% | 7.10% |
| | Rice bran oil | 2.60% | 1.80% |
| | Garlic | 1.50% | 1.10% |
| | Boiled Potato, | 54.40% | 37.60% |
| | Mashed | | |
| | Boiled Carrots, | 16.50% | 11.40% |
| | Mashed | | |
| | Turmeric | 0.30% | 0.20% |
| | Garam Masala | 0.40% | 0.30% |
| | Salt | 0.60% | 0.40% |
| | Pepper | 0.20% | 0.10% |
| | Chilli pepper green, | 5.10% | 3.50% |
| | chopped | | |
| | Coriander fresh | 0.50% | 0.40% |
| | Peas | 7.70% | 5.30% |
| | Totals | 100.00% | 100.00% |

### Method:

Pastry: Combine glycerine, egg yolk and water in a jug. Mix flour, soy protein isolate and salt in a bowl. Make a well into the centre and add the oil and water/glycine/egg to make a firm dough. Knead the dough until smooth and roll into a ball. Refrigerate and leave to stand for 30 minutes.

Filling: Add oil and onions, turmeric, garam masala, salt and pepper to a cooking vessel and fry until onion is translucent. Add potato, carrot, chilli pepper and garlic. Cook for a further 10 minutes. Add peas and cook for a further 3 minutes. Add coriander and set aside.

Samosa: The pastry should be sheeted and cut into circles. The pastry cases should be formed and filled such that the ratio of filling to pastry is approximately 70:30 and samosa of approximately 72 g are produced. The formed and filled samosa should be baked at approximately 180° C. for 20-25 minutes. Moisture loss on baking of about 25%, will produce samosa with a baked weight approximately 54 g and the desired nutritional composition.

The product may then be snap frozen and packaged.

### Example 5

A frozen meal which provides about 50% of the NRV for the macronutrients protein, carbohydrate and fat.

| | |
|---|---|
| Protein | 25 g |
| Carbohydrate | 155 g |
| Fat | 35 g |

In this example this frozen meal is a chilli con came, with a serving size of 740 g for people who may have missed lunch or breakfast.

### Formulation and Method to Achieve Example 5

| | % of in-going ingredient |
|---|---|
| Ingredient | weight |
| Rice Bran Oil | 1.60% |
| Onion | 6.40% |
| Capsicum red | 4.90% |
| Garlic | 0.40% |
| Chilli Powder | 0.20% |
| Paprika | 0.20% |
| Cumin | 0.20% |
| Beef mince, 70% lean | 11.70% |
| Avon maize starch | 6.60% |
| Maltodextrin | 3.30% |
| Water | 16.60% |
| Acacia gum | 1.80% |
| Beef stock dried | 0.40% |
| Chopped Tomatoes | 33.13% |
| Sugar | 0.30% |
| Tomato puree | 2.10% |
| Salt | 0.20% |
| Kidney beans, cooked | 9.90% |
| and drained | |
| Totals | 100% |

### Method:

The rice bran oil should be heated in a cooking vessel before adding the chopped onion and cooking until caramelized. The diced capsicum, chopped garlic and spices should then be added to the mixture and cooked for a further 5 minutes. The beef mince should then be added and cooked with agitation/stirring until fully browned.

In a separate cooking vessel, a slurry should be prepared comprising the water (@ 50-60° C.), maize starch, maltodextrin, acacia gum and beef stock. Pre-blending of these dry powders will aid the dispersion of the acacia gum. The slurry is then added to the cooking mixture, which should be heated to boiling before reducing the heat to a simmer. The chopped tomatoes, sugar, salt, tomato puree and drained kidney beans should then be added and stirred in. The entire mixture should be heated to approximately 100° C. (without boiling) and cooked for further 10 minutes. The cooked mixture may then be cooled, before portioning with boiled/drained white rice, comprising a finished meal of 42% chilli con carne/58% rice. 740 g portions are then packaged in microwavable plastic trays and blast frozen.

### Example 6

A liquid food for naso-gastric delivery which contains 95% of the NRV for the macronutrients protein, carbohydrate and fat and 100% for fibre.

| | |
|---|---|
| Protein | 47.5 g |
| Carbohydrate | 294.5 g |
| Fat | 66.5 g |

### Formulation and Method to Achieve Example 6

Liquid food for nasogastric delivery—2690 ml packaged in a sterile bladder.

| | | % in-going |
|---|---|---|
| | Ingredient | ingredient weight |
| Part A | Soy protein isolate | 0.40% |
| | Whey Protein | 0.30% |
| | Concentrate | |
| | Whole milk powder | 4.50% |
| | Water | 23.80% |
| Part B | Maltodextrin | 0.80% |
| | Carageenan | 0.05% |
| | Microcrystaline | 0.40% |
| | cellulose | |
| | Inulin | 0.30% |
| | Rice Syrup Solids | 4.40% |
| | Water | 56.00% |
| Part C | Brown Rice Syrup | 6.00% |
| | Glycerine | 0.60% |
| Part D | Rice Bran Oil | 0.80% |
| | Sunflower oil | 0.40% |
| Part E | Vanilla flavour | 1.40% |
| | Totals | 100.00% |

### Method:

The soy protein isolate, whey protein concentrate and whole milk powder should be dispersed using shear/agitation in Part A water (@40-50° C.) and left to hydrate (assisted by agitation) for 10-15 minutes. In a separate vessel, the carrageenan, microcrystalline cellulose, maltodextrin, rice syrup solids and inulin should be dispersed in Part B water (@40-50° C.). Dispersion may be aided by pre-blending of the dry powders. These should be left to hydrate (with agitation) for 15-20 minutes, prior to adding and blending the brown rice syrup and glycerine (part C) and the soy protein isolate/whole milk powder/whey protein concentrate solution (Part A). The rice bran oil and sunflower oil (Part D) should then be added and blended using high shear. Finally the flavor is added and mixed. This mixture is then processed by ultra heat treatment (approximately 140° C. for 6-7 seconds) and homogenized, prior to aseptic packaging into a sterile bladder.

### DETAILED DISCUSSION OF ALTERNATIVE WAYS TO IMPLEMENT THE INVENTION

In some embodiments the actual age group of a child or adult may be further classified into one or more further categories. For example:
A food or beverage substantially as described above wherein the average daily energy requirements are also calculated based on whether the child or adult is a female or male.
A food or beverage substantially as described above wherein the age group of the adult or child is taken into consideration when calculating the energy requirements.

In some embodiments the average daily energy requirements may be based on those of an average. For example the daily energy requirements can be based on an adult female such as is used for the GDA, or an average of the figures for males and females which is used in the Australia New Zealand Food Standards.

In such embodiments the NRV for energy may be around 8000-9000 kJ or around 2000-2100 Cal. The advantage of selecting an NRV calculated on the average daily energy requirements is that for many applications of the invention it helps enable low cost manufacturing as a single food or beverage product can be produced from a production line. In some embodiments the NRV may be calculated based on an average daily energy requirement for adults and another for children under 10 years of age.

In some embodiments the food or beverage according to the invention may be formulated to have a long shelf life.

In some embodiments the food or beverage product according to the invention includes one or more essential minerals and vitamins in the same relative proportion of the NRV as the selected macronutrients. In some embodiments the minerals and vitamins may include one or more of vitamins A, B1, B2, B6, B12, C, D and E; niacin; foliate; calcium; iodine; iron; magnesium; phosphorous; and zinc.

In some embodiments the food product of the present invention has a shelf life of at least three months.

Aspects of the present invention as detailed herein have been described by way of example only and it should be appreciated that modifications and additions may be made thereto without departing from the scope of the appended claims.

1. A process for manufacturing a food or beverage product which is based upon the nutritional reference values (NRV) as a starting point and which has the macronutrients of protein, carbohydrate and fat all balanced with respect to their relative percentage of the NRV and has fibre present in an amount which exceeds the relative percentage of the NRV to which the aforementioned macronutrients are matched, the process comprising the steps of:
(i) selecting a percentage of the NRV that will be used to determine the amount of protein, carbohydrate and fat in the product, from any one of the following documents:
Daily Reference Values given in USFDA Code of Federal Regulations 21 CFR 101.9, 1996;
% Daily Intake reference values given in the Australia New Zealand Food Standards;
GDA—Guideline Daily Amounts as published by the Food and Drink Federation, UK;
Reference Standards given in The Canadian Food and Drug Regulations and amendments;
all as published on 13 Mar. 2012; and
(ii) combining the protein, carbohydrate, fat macronutrients in amounts that accord to the selected percentage of the NRV so that each complete serving of the product has substantially the same percentage of the NRV;
(iii) adding fiber to the product so that a complete serving of the product provides fiber in a proportion of the NRV that is at least 5% greater than the percentage of the NRV provided by the fat, protein or carbohydrate in a serving.

2. A pre-packaged food or beverage product comprising: macronutrients in the form of protein, carbohydrate, and fat wherein each complete serving of the product has substantially the same relative proportions of the nutritional reference values (NRV) for each macronutrient selected from:
Daily Reference Values given in USFDA Code of Federal Regulations 21 CFR 101.9, 1996;
% Daily Intake reference values given in the Australia New Zealand Food Standards;
GDA—Guideline Daily Amounts as published by the Food and Drink Federation, UK;
Reference Standards given in The Canadian Food and Drug Regulations and amendments;
all as published on 13 Mar. 2012; and
wherein the fiber content in the serving provides a proportion of the NRV that is at least 5% greater than the proportions of the NRV provided by the fat, protein or carbohydrate in a serving.

3. A pre-packaged food or beverage product as claimed in claim 2 wherein the proportion of the NRV selected for the macronutrients is selected from substantially 5% of the NRV.

4. A pre-packaged food or beverage product as claimed in claim 2 wherein the proportion of the NRV selected for the macronutrients is selected from substantially 50-95% of the NRV.

5. A pre-packaged food or beverage as claimed in claim 2 which includes one or more minerals and vitamins in the same relative proportions of the NRV as the selected macronutrients.

6. A pre-packaged food or beverage product comprising: macronutrients in the form of protein, carbohydrate and fat wherein each complete serving of the product has the same relative proportions of the NRV for each macronutrient and wherein the fibre content in the serving provides a proportion of the NRV that is at least 5% greater than the proportions of the NRV provided by the fat, protein or carbohydrate in a serving,
wherein the proportions if the NRV are selected from any one of the following documents:
Daily Reference Values given in USFDA Code of Federal Regulations 21 CFR 101.9, 1996;
% Daily Intake reference values given in the Australia New Zealand Food Standards;
GDA—Guideline Daily Amounts as published by the Food and Drink Federation, UK;
Reference Standards given in The Canadian Food and Drug Regulations and amendments;
all as published on 13 Mar. 2012.

7. (canceled)

8. (canceled)
